(19) United States
(12) Patent Application Publication
(10) Pub. No.: US 2010/0201506 A1
(43) Pub. Date: Aug. 12, 2010

(54) TRAILER TATTLER

(76) Inventor: Jeffery Terry, Dequeen, AR (US)

Correspondence Address: Cionca Law Group P.C., 333 City Blvd W, Ste 1700, Orange, CA, 92868, US

(21) Appl. No.: 12/705,358

(22) Filed: Feb. 12, 2010

Related U.S. Application Data
(60) Provisional application No. 61/151,900, filed on Feb. 12, 2009.

(51) Int. Cl. G08B 21/00

(52) U.S. Cl. 340/431

(57) ABSTRACT

The present invention, Trailer Tattler, effectively alerts drivers, that a trailer is connected to the back of the vehicle, with an audible sound and/or a visual signal or message. This system prevents anyone from getting in the vehicle and beginning to drive, when they may be unaware that a trailer is attached. This system would be useful to anyone who uses a vehicle to pull a trailer of any type. The audio and/or the visual alert of the current invention could assist in avoiding accidents and help to promote conscious driving.

### CROSS-REFERENCE TO RELATED APPLICATIONS

This application claims priority from U.S. Provisional Application Ser. No. 61/151,900, filed on Feb. 12, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to the automotive industry.

2. Description of the Related Art

For individuals who use vehicles to pull trailers, it can be often difficult to remember when the trailer is attached to the vehicle and when it is not. This is especially true when the vehicle is more often used without a trailer. If the driver is preoccupied when getting behind the wheel of a vehicle to which a trailer is attached, an accident can occur.

Driving with a trailer takes specific maneuvering and cautious driving. For example, when someone backs up a vehicle, without knowing that a trailer is attached, it is very likely that an accident will occur. The accident may be the cause of serious property damage and/or personal injury.

### BRIEF SUMMARY OF THE INVENTION

The present invention, Trailer Tattler, effectively alerts drivers, that a trailer is connected to the back of the vehicle, with an audible sound and/or a visual signal. This system prevents anyone from getting in the vehicle and beginning to drive, when they may be unaware that a trailer is attached. This system would be useful to anyone who uses a vehicle to pull a trailer of any type. The audio and/or the visual alert of the current invention could assist in avoiding accidents and help to promote conscious driving.

### BRIEF DESCRIPTION OF THE DRAWINGS

For exemplification purposes, and not for limitation purposes, embodiments of the invention are illustrated in the figures of the accompanying drawings, in which:

FIG. 1 illustrates the top view of a trailer attached to a vehicle while the vehicle is backing up. It shows what could happen without the system of the present invention.

FIG. 2 illustrates the side view of a trailer attached to a vehicle which has the system of the present invention installed, in accordance with an embodiment of the present invention.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

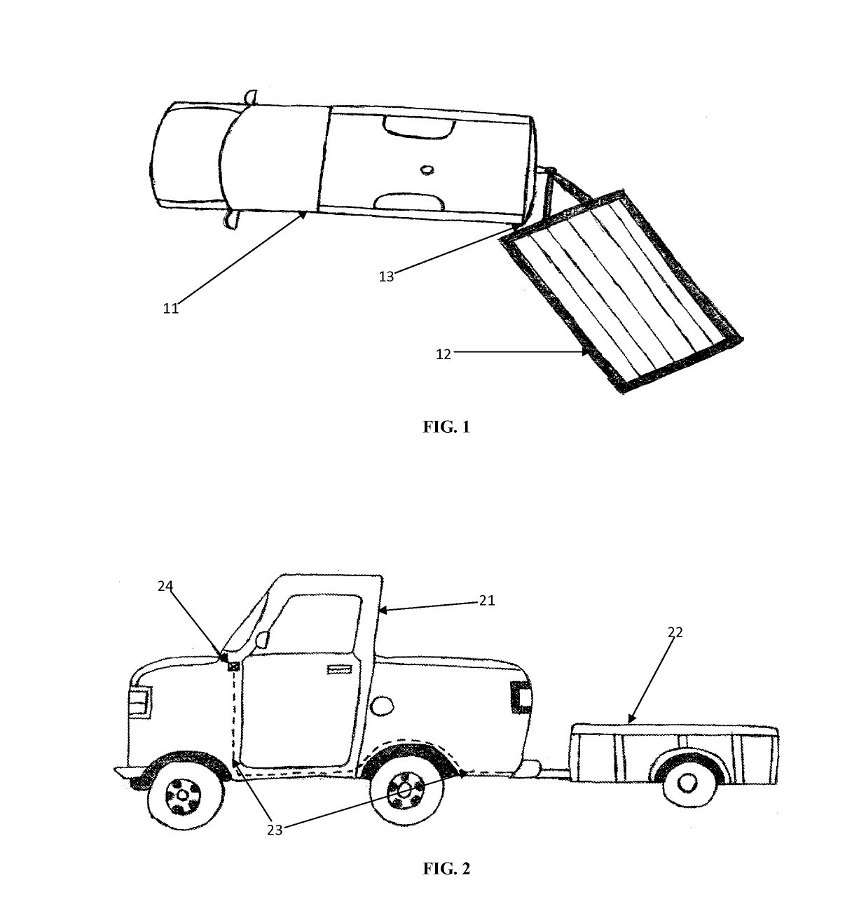

FIG. 1 illustrates the top view of a trailer 12 attached to a vehicle 11 while the vehicle is backing up. FIG. 1 shows an example of what could happen, without the system of the present invention being installed on the vehicle, while the vehicle is backing up. Damage to the rear-left area of the vehicle 13 and to the front-left area of the trailer may occur. It should be recognized by someone of ordinary skills in the art that other types of property damages may occur. For example, the right area of the vehicle and trailer may be damaged and/or personal and/or real property which may exist in the proximity of the trailer and/or vehicle may be damaged. More importantly, without the system of the present invention in place, there is an increased risk that people situated in the vicinity of the trailer or vehicle may be injured. It should be also recognized that property damage and /or personal injury may occur not only when the vehicle is backed up but also in any other special maneuvering or driving situations (e.g., sudden braking) involving a vehicle-trailer assembly.

FIG. 2 illustrates the side view of a trailer 22 attached to a vehicle 21 which has the system of the present invention 23, 24 installed, in accordance with an embodiment of the present invention. Trailer Tattler is an alert system designed primarily for the inside of vehicles. In one embodiment of the present invention, the system comprises a set of electrical wires 23 and a device 24 capable of sending an audio and/or visual alert to the driver of the vehicle when the device is electrically activated. This system makes the driver aware that a trailer is attached to the rear of the vehicle. The system may be prewired into the trailer's electrical connection to the vehicle. This would be the same system that controls the turn signals and brake lights. When the trailer is connected to the vehicle, the first uninterrupted wire connection (e.g., plus or minus) between the device 24 and the power source of the vehicle would be created. A second electrical wire connects the device 24 to one or more of the systems of the vehicle, as for example, the ignition system. This second wire, which is connected to a system of the vehicle, closes the circuit between the device 24 and the power source of the vehicle only when the respective system is itself activated mechanically or electrically. For example, when the second wire is connected to the ignition system of the vehicle, the circuit to the device 24 would be closed, and the device 24 therefore activated, when the driver of the vehicle would start the engine of the vehicle.

Similarly, the second wire of the device 24 can be connected to the transmission system of the vehicle in order to activate the device 24 when the driver attempts to back up the vehicle. This can be achieved by the use of a switch to be activated when the transmission is set in reverse mode or by connecting the second wire of the device 24 directly into the electrical circuit of the backup lights of the vehicle.

Someone of ordinary skills in the art would recognize that the device 24 can be connected to and activated only by one vehicle system or by two or more systems. For example, the device 24 can be connected to both, the ignition and the transmission system, hence, ensuring that the driver is alerted of the existence of the trailer twice: first when he starts the engine, and secondly, when he sets the vehicle's transmission in reverse.

It should be recognized that additional systems or components of the vehicle, alone or in combination with others, can be used to activate the device 24. For example, the second wire of the device 24 can be connected to and activated by the brake system, turn signal system and/or the door open/close system.

In a preferred embodiment of the present invention, when activated as explained earlier, the device 24 will emit an audio and/or a visual alert to the driver. The audio alert may be a beep, a series of beeps, or any other desired sound that will alert the driver. One such sound could be a prerecorded message like the following: “Warning! Trailer Attached!” The same or another warning message could also be displayed by the device on a small screen in a static or intermittent mode to alert the driver visually. Other visual alerts may be employed as for example a flashing light of various sizes and colors. The device 24 can be designed to employ an audio alert only, a visual alert only or a combination of both.

The device 24 can be preprogrammed to send the alert for a predetermined amount of time after its activation, after which it will stop by itself, without any input from the driver. The device 24 can also be designed to give the option to the driver to turn it off. For example, a switch, actionable by the driver could be employed to turn off the audio alert, the visual alert or both.

Someone of ordinary skills in the art would recognize that integration of the present invention with the existing audio or video devices of the vehicle would be an alternative embodiment of the present invention. For example, the audio alert could be generated by the device 24 and broadcasted through the speakers already installed in the vehicle, or it could be generated and broadcasted by a noise making device which was preinstalled in the vehicle for another specific purpose or for a general purpose. Furthermore, the present invention could be integrated by the manufacturer of the vehicle in the design and manufacture of the vehicle. For example, the visual alert message could be displayed in an area of the instrument panel of the vehicle.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A device installed onto a vehicle and so constructed as to send an alert to the driver of said vehicle that a trailer is attached to the said vehicle.

2. The device of claim 1, wherein the said alert is an audio alert.

3. The device of claim 1, wherein the said alert is a visual alert.

4. The device of claim 1, wherein the said alert is a combination of an audio alert and a visual alert.

5. The device of claim 1, wherein the said alert is sent to the said driver at the time the engine of the said vehicle is started.

6. The device of claim 1, wherein the said alert is sent to the said driver at the time the transmission of the said vehicle is set in reverse.

7. The device of claim 1, wherein the said alert is sent to the said driver at the time the braking system of the said vehicle is activated.

8. The device of claim 1, wherein the said alert is sent to the said driver at the time the turn signal system of the said vehicle is activated.

9. The device of claim 1, wherein the said alert is sent to the said driver at the time a door of the said vehicle is open.

10. The device of claim 1, wherein the said alert is sent to the said driver at the time a door of the said vehicle is close.

11. A system for alerting the driver of a vehicle that a trailer is attached to the said vehicle and comprising:
a device capable of sending alerts to the driver of a vehicle when the said device is electrically activated; and,
an electrical connection, between said device and the electrical power source of said vehicle, so constructed as to activate said device at the time a system of the said vehicle is activated, if a trailer is attached to the said vehicle.

12. A method of alerting the driver of a vehicle that a trailer is attached to the said vehicle and comprising:
installing inside the said vehicle a device capable of sending alerts to the driver of said vehicle when the said device is electrically activated; and,
installing an electrical connection, between said device and the electrical power source of said vehicle, so constructed as to activate said device at the time a system of the said vehicle is activated, if a trailer is attached to the said vehicle.
